(19) United States
(12) Patent Application Publication
(10) Pub. No.: US 2026/0246916 A1
(43) Pub. Date: Aug. 20, 2026

(54) INFORMATION EXCHANGE METHOD AND APPARATUS, DISPLAY DEVICE, AND STORAGE MEDIUM

(71) Applicant: BEIJING BYTEDANCE NETWORK TECHNOLOGY CO., LTD., Beijing (CN)

(72) Inventors: Zhenhua YU, Beijing (CN); Jing WANG, Beijing (CN); Xianchao SHEN, Beijing (CN)

(21) Appl. No.: 18/843,227

(22) PCT Filed: Feb. 21, 2023
(86) PCT No.: PCT/CN2023/077289

§ 371 Date: Aug. 30, 2024

(30) Foreign Application Priority Data
Mar. 2, 2022 (CN) 202210198250.5

(51) Int. Cl. H04N 13/398; G06F 3/01; G06F 3/04886; H04W 4/80; H04W 76/14

(52) U.S. Cl. CPC H04N 13/398; G06F 3/011; G06F 3/04886; H04W 4/80; H04W 76/14

(57) ABSTRACT

An information exchange method and apparatus, a display device, and a storage medium are disclosed. The method is applied to a client, in which the client is deployed on a head-mounted display device connected to a terminal device, and the method includes: displaying a projection window and displaying projection information in the projection window, wherein the projection information is information projected by the terminal device to the head-mounted display device; and in response to an input event acting on the projection window, displaying the projection information corresponding to the input event in the projection window.

The present application claims the priority and benefits of Chinese Patent Application No. 202210198250.5, filed with the Chinese Patent Office on Mar. 2, 2022, which is incorporated herein by reference in its entirety as part of the present application.

### TECHNICAL FIELD

Embodiments of the present disclosure relate to the field of human interface technology, for example, to an information exchange method, an apparatus, a display device, and a storage medium.

### BACKGROUND

With the maturity and development of various technologies, head-mounted display devices (hereinafter referred to as HMDs for short) are more and more widely used.

However, as a latecomer, ecosystems of the HMDs are quite different from those of smartphones, so to a large extent, the content displayed in the HMDs needs to be projected from the smartphones, such as three-dimensional (3D) videos, and 3D games. However, users wearing the HMDs can only watch the content projected from the smartphones, resulting in low user's experience.

### SUMMARY

An embodiment of the present disclosure provides an information exchange method and apparatus, a display device, and a storage medium, aiming to realize the effect of a user operating a terminal apparatus while wearing the HMD.

In the first aspect, embodiments of the present disclosure provide an information exchange method, applied to a client, in which the client is deployed on a head-mounted display device connected to a terminal device, and the method may include:
displaying a projection window, and displaying projection information in the projection window, in which the projection information is information projected by the terminal device to the head-mounted display device; and
in response to an input event acting on the projection window, displaying the projection information corresponding to the input event in the projection window.

In the second aspect, embodiments of the present disclosure further provide an information exchange apparatus, configured in a client, in which the client is deployed on a head-mounted display device connected to a terminal device, and the apparatus includes: the first projection information display module and the second projection information display module;
the first projection information display module is configured to display a projection window, and display projection information in the projection window, in which the projection information is information projected by the terminal device to the head-mounted display device; and
the second projection information display module is configured to, in response to an input event acting on the projection window, display the projection information corresponding to the input event in the projection window.

In the third aspect, embodiments of the present disclosure further provide a head-mounted display device, which may include:
at least one processor; and
a storage is configured to store at least one program,
when the at least one program is executed by the at least one processor, the at least one processor implements the information exchange method in any embodiment of the present disclosure.

In the fourth aspect, embodiments of the present disclosure further provide a computer-readable storage medium, the computer-readable storage medium storing a computer program, the computer program when executed by a processor realizing the information exchange method provided by any embodiment of the present disclosure.

### BRIEF DESCRIPTION OF DRAWINGS

Throughout the accompanying drawings, identical or similar drawing marks indicate the same or similar elements. It is to be understood that the accompanying drawings are schematic in nature and that the originals and elements are not necessarily drawn to scale.

FIG. 1 is a flowchart of an information exchange method according to a first embodiment of the present disclosure;

FIG. 2 is a flowchart of an information exchange method according to a second embodiment of the present disclosure;

FIG. 3 is a flowchart of the first optional example of an information exchange method according to a second embodiment of the present disclosure;

FIG. 4 is a flowchart of the second optional example of an information exchange method according to a second embodiment of the present disclosure;

FIG. 5 is a time sequence diagram of an information exchange method according to a third embodiment of the present disclosure;

FIG. 6 is a block diagram of an information exchange apparatus according to a fourth embodiment of the present disclosure; and

FIG. 7 is a structural schematic diagram of a head-mounted display device according to a fifth embodiment of the present disclosure.

### DETAILED DESCRIPTION

Embodiments of the present disclosure will be described in more detail below with reference to the accompanying drawings. It is to be understood that all steps in embodiments of a method according to the present disclosure may be performed in different sequences, and/or performed in parallel. Furthermore, the embodiments of the method may include additional steps and/or illustrated steps that are omitted to perform. The scope of the present disclosure is not limited in this respect.

The term “include” and its variations as used herein mean openly including, i.e. “including but not limited to”. The term “based on” is “at least partially based on”. The term “one embodiment” means “at least one embodiment”; the term “another embodiment” means “at least one additional embodiment”; and the term “some embodiments” means “at least some embodiments”. Relevant definitions of other terms are given in the following description.

It is to be noted that the concepts of “first”, “second”, etc. mentioned in the present disclosure are only used for distinguishing different apparatuses, modules or units, and are not to limit the function performing sequence or interdependence of these apparatuses, modules or units.

It is to be noted that the modifications of “one” and “plurality” mentioned in the present disclosure are schematic rather than restrictive, and those skilled in the art should understand that unless otherwise expressly indicated in the context, it should be understood as “at least one”.

The names of messages or information exchanged between a plurality of apparatuses according to the embodiments of present disclosure are for illustrative purposes only and are not intended to limit the scope of such messages or information.

In each embodiment described below, an optional feature and an example are provided in each embodiment at the same time, and all features described in the embodiments can be combined to form a plurality of alternative solutions, and each numbered embodiment should not be regarded as only a technical solution.

Before introducing the embodiments of the present disclosure, the application scenarios of the embodiments of the present disclosure are illustrated with examples: there are many types of HMDs, such as Virtual Reality (VR) HMD, Augmented Reality (AR) HMD, and Mixed Reality (MR) HMD and the like. In order to more vividly elaborate the technical solutions in the embodiments of the present disclosure, the VR HMD are taken as an example, but it is to be emphasized that this is only an example and is not a limitation of the scope of application of the embodiments of the present disclosure. A user wearing the VR HMD may watch the content projected from a smartphone through the VR HMD, but cannot operate the smartphone. Exemplarily, when the user watches a projected movie with the VR HMD, the smartphone receives an information alert, and the user may watch the information alert, but cannot click the information alert to browse the information details. In order to browse the information details, the user needs to take off the VR HMD, and then operates the smartphone to click on the message alert to browse the information details. Definitely, the above solution has caused a poor user's experience.

### First Embodiment

FIG. 1 is a flowchart of an information exchange method according to the first embodiment of the present disclosure. This embodiment is applicable to information exchange conditions, and particularly applicable to a condition that a user operates a VR head-mounted display device (HMD) to run a terminal device to realize information exchange. This method may be executed by an information exchange apparatus according to this embodiment of the present disclosure, the apparatus may be realized in a form of software and/or hardware, and the apparatus may be integrated on the VR HMD, and the VR HMD is connected with the terminal device.

As shown in FIG. 1, the method according to this embodiment of the present disclosure includes the following steps:
S110, displaying a projection window, and displaying projection information in the projection window, in which the projection information is information projected by the terminal device to the head-mounted display device.

The projection window is displayed in a VR HMD, the projection window may be a window used for displaying the projection information, and the projection information may be information projected by the terminal device to the VR HMD, such as text information, image information and video information and the like; and the terminal device may be any electronic device with the projection function, such as a smartphone, a tablet computer, a desktop computer and a notebook computer and the like. The VR HMD is connected with the terminal device, for example, the connection mode may be projection connection, which means that after the projection function of the terminal device is started, the projection information may be transmitted to the VR HMD, and then the VR HMD may display the received projection information on the projection window, so that the user with the VR HMD may browse the projection information. Under normal conditions, the projection information displayed on the VR HMD is the same as the projection information displayed on the terminal device, however, the former is 3d information, and the latter is 2d information.
S120, in response to an input event acting on the projection window, displaying the projection information corresponding to the input event in the projection window.

The input event may be an event, such as a keyboard event, and a touch event and the like, acting on the projection window (namely, expect to control the terminal device) and triggered by the user controlling a certain input device; the input device may be an input device of the VR HMD, such as a handle, and a keyboard and the like used in match with the VR HMD, and the VR HMD is equivalent to a display device at the moment. After receiving the input event, the VR HMD, in response to the input event, display the projection information corresponding to the input event on the projection window, and the projection information may be information generated after the terminal device responds to the input event. In practical application, optionally, the virtual keyboard may be displayed in the projection window; when the input event includes the keyboard event acting on the virtual keyboard, the projection information corresponding to the input event may include an input character corresponding to the keyboard event, that is, the input character acquired by the user tapping the virtual keyboard may be displayed in the projection window; and optionally, when the input event includes the touch event, the projection information corresponding to the input event may include projection information in at least one state, such as projection information in a sliding state, projection information in a page turning state, projection information converted from a partial display state to a complete display state (like from information alert to information details) and the like, and no limitation is made here.

It is to be noted that the input event is an event triggered after the user controls the VR HMD (for example, the user may control a certain input device to run the VR HMD); and after the VR HMD responds to the input event, the projection information which is generated by the terminal device, projected and corresponds to the input event may be displayed in the projection window, which indicates that the user successfully operates the terminal device by operating the VR HMD, and at the moment, the VR HMD may serve as the input device of the terminal device, rather than serving as a pure display device. Therefore, the user wearing the VR HMD can watch the projection information projected by the terminal device, and can directly operate the terminal device, thus improving the use experience of the user.

In the technical solution of the embodiment of the present disclosure, the VR HMD is connected with the terminal device, and the VR HMD displays the projection information projected by the terminal device to the VR HMD through the displayed projection window; and in response to the input event acting on the projection window, the projection information corresponding to the input event is displayed in the projection window, and the projection information corresponding to the input event may be the projection information generated by the terminal device after responding to the input event. The above technical solution, the user wearing the VR HMD can operate the VR HMD to run the terminal device, thus improving the use experience of the user in watching the projection information with the VR HMD.

An optional technical solution, on the basis of the First embodiment, after displaying the projection window, the information exchange method may further include: registering a pre-configured window event detector for the projection window, the window event detector is configured to detect the input event acting on the projection window. That is, in order to successfully detect the input event acting on the projection window, the window event detector may be pre-registered, and the window event detector may be pre-configured (i.e. pre-coded) and may be configured to detect a code segment of the input event acting on the projection window. After the window event detector is successfully registered, the input event may be detected at any time, thus effectively ensuring timely response to the input event.

### Second Embodiment

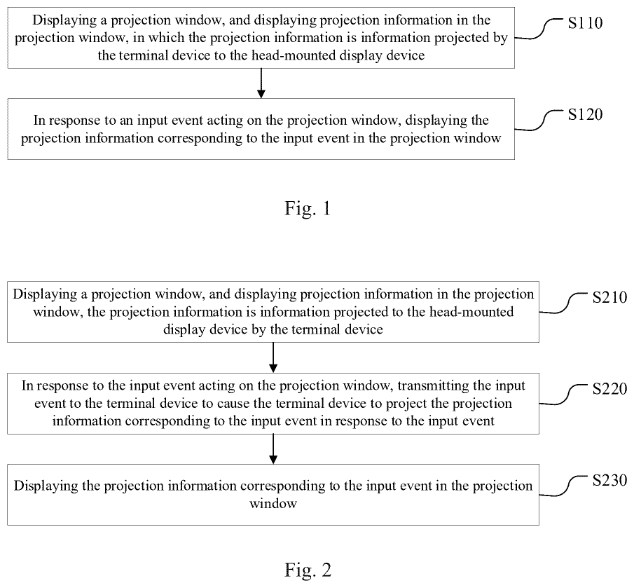

FIG. 2 is a flowchart of an information exchange method according to the second embodiment of the present disclosure. This embodiment is refined on the basis of each optional solution in the above embodiment. In this embodiment, optionally, after responding to the input event acting on the projection window, the information exchange method may further include: transmitting the input event to the terminal device to cause the terminal device to project projection information corresponding to the input event in response to the input event. The interpretation of terms identical or corresponding to those in each above embodiment are not repeated herein.

Correspondingly, as shown in FIG. 2, the method according to this embodiment may include the following steps:
S210, displaying a projection window, and displaying projection information in the projection window, in which the projection information is information projected to the head-mounted display device by the terminal device.
S220, in response to the input event acting on the projection window, transmitting the input event to the terminal device to cause the terminal device to project the projection information corresponding to the input event in response to the input event.

The VR HMD may be used as an input device of the terminal device, and may be an input device (namely an HID input device) for realizing Human Interface Devices (HID) accurately, so that the VR HMD may transmit the input event to the terminal device in response to the input event, then the terminal device, in response to the received input event, generates the projection information corresponding to the input event, and finally the projection information is projected, and the user may directly watch the projection information after own control in the VR HMD, thereby realizing the effect of operating the VR HMD to run the terminal device.
S230, displaying the projection information corresponding to the input event in the projection window.

In the technical solution of this embodiment of the present disclosure, the VR HMD is used as the HID input device of the terminal device, so the VR HMD can transmit the received input event to the terminal device, and the terminal device successfully responds to the input event, and therefore, the effect that the user operates the VR HMD to run the terminal device is realized.

An optional technical solution, on the basis of the Second embodiment, the transmitting the input event to the terminal device, then projecting projection information corresponding to the input event through the terminal device in response to the input event includes: acquiring an event type of the input event, and encapsulating the input event as a Bluetooth event matched with the event type; and transmitting the Bluetooth event through a Bluetooth channel to the terminal device to cause the terminal device to project the projection information corresponding to the Bluetooth event in response to the Bluetooth event. In order to reduce the modification workload and be compatible with various terminal devices on the market, the input event may be transmitted in a Bluetooth transmission mode. In other words, the present technical solution only needs to transform an ecological system of the VR HMD, without transforming the ecosystem of the terminal device, so that it can be compatible with various terminal devices that support Bluetooth on the market. The event type may reflect what the input event is, such as a keyboard event, and a touch event and the like; the input event is encapsulated as the Bluetooth event matched with the event type, and thus the acquired Bluetooth event can be transmitted to the terminal device through the Bluetooth channel; and the Bluetooth channel may be a channel used for realizing Bluetooth transmission between the VR HMD and the terminal device. After receiving the Bluetooth event, the terminal device may project the corresponding projection information to the VR HMD in response to the Bluetooth event. It is to be noted that the input event and the Bluetooth event are the same in essence, here it is just to encapsulate the input event as the Bluetooth event by completing the event transmission with the help of the Bluetooth channel. According to the technical solution above, the effect of operating the VR HMD to run the terminal device in a mode of being low in modification workload and capable of being compatible with various terminal devices that support Bluetooth on the market is achieved.

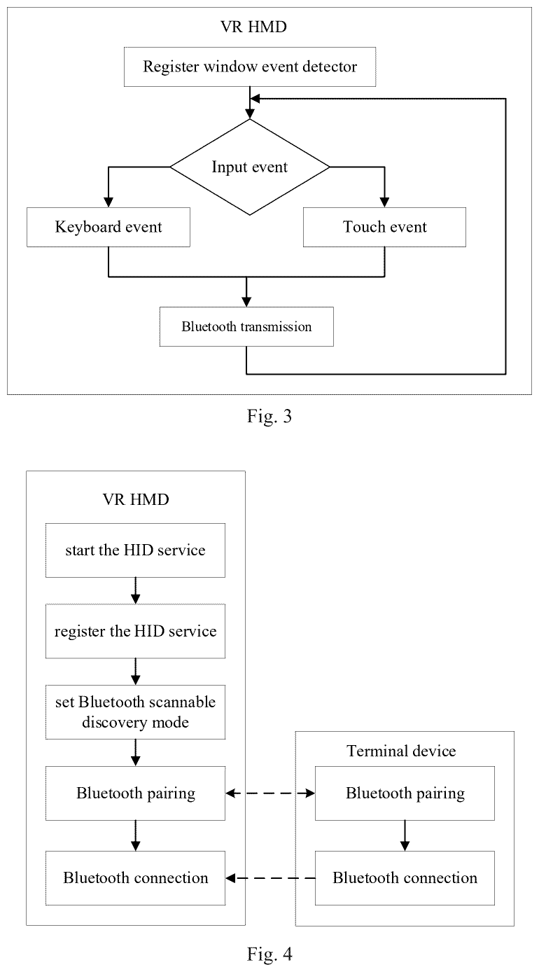

In order to better understand the working process of the VR HMD on the whole, the working process is exemplarily explained below with specific examples. Exemplarily, as shown in FIG. 3:
1, the VR HMD and the terminal device are subjected to projection connection, and after the user in the use of the projection function, the projection window is displayed, and a window event detector is automatically registered;
2, the input event acting on the projection window is detected through the window event detector;
3, when the input event is the keyboard event, the input event will be encapsulated as the Bluetooth event (namely a Bluetooth keyboard event) corresponding to the keyboard event according to a Bluetooth protocol standard;
4, when the input event is the touch event, the input event will be encapsulated as a Bluetooth event (namely a Bluetooth touch event) corresponding to the touch event according to the Bluetooth protocol standard;
5, the encapsulated Bluetooth event is transmitted to the terminal device through the Bluetooth channel, and then the terminal device responds to the Bluetooth event; and
6, step 2 is returned.

On that basis, optionally, the information exchange method may further include: registering as a Bluetooth human interface device to serve as an input device of the terminal device for realizing human interface so as to realize the transmitting operation of the input event; and establishing the Bluetooth channel to the terminal device to realize Bluetooth connection to the terminal device through the Bluetooth channel. The VR HMD is registered as the Bluetooth HID, the registered VR HMD is served as the input device of the terminal device for realizing HID, and therefore the transmitting operation of the input event is realized. The Bluetooth connection between the VR HMD and the terminal device is achieved by establishing the Bluetooth channel between the VR HMD and the terminal device, which is an important premise for successful transmitting of subsequent input events. According to the technical solution above, the registration of the Bluetooth HID device and the establishment of the Bluetooth channel effectively ensures the successful transmitting of the subsequent input event.

Optionally, the registering as a Bluetooth HID may include: in response to a start instruction of a HID service, starting the HID service, and registering the started HID service, thereby registering the HMD as the Bluetooth HID, the HID service including a service used for representing that the Bluetooth is used as the HID service for application in the Bluetooth protocol. The HID service may be one service in the Bluetooth protocol, and is used for representing that the Bluetooth is used as the HID service for application. After the ecological system of the VR HMD is transformed, the user may start the HID service. The VR HMD, in response to the start instruction of the HID service, starts the HID service, and register the started HID service, thereby realizing the effect of registering the VR HMD as the Bluetooth HID device.

In order to better understand the interaction process of the VR HMD and terminal device on the whole, the method is exemplarily explained below with specific examples. Exemplarily, as shown in FIG. 4:
1, the user starts the HID service in the VR HMD;
2, the VR HMD automatically registers the HID service;
3, the user sets a Bluetooth scannable discovery mode in the VR HMD;
4, the terminal device starts Bluetooth pairing and performs Bluetooth pairing with the VR HMD; and
5, after the terminal device is successfully paired with the VR HMD, the terminal device is connected with the VR HMD through Bluetooth.

### Third Embodiment

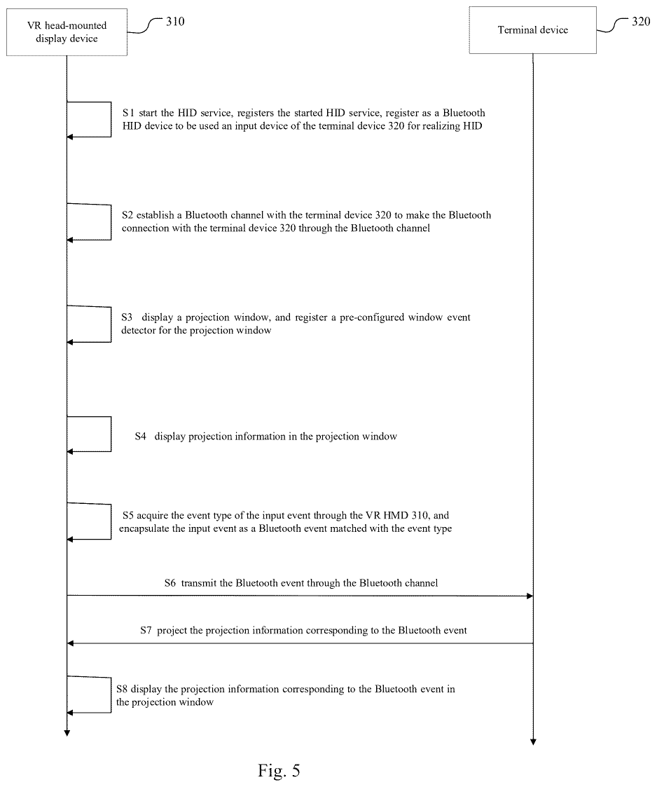

FIG. 5 is a time series diagram of an information exchange method according to the third embodiment of the present disclosure. This embodiment is refined on the basis of each optional solution in the above embodiment. The interpretation of terms identical or corresponding to those in each above embodiment are not repeated herein.

Correspondingly, as shown in FIG. 5, the method according to this embodiment involves a VR head-mounted display device (HMD) 310, and a terminal device 320 in projection connection with the VR HMD 310, and the method may include the following steps:
S1, the VR HMD 310, in response to a start instruction of a HID service, starts the HID service, registers the started HID service, registers as a Bluetooth HID device to be used an input device of the terminal device 320 for realizing HID, the HID service is a service used for representing that the Bluetooth is used as the HID service for application in a Bluetooth protocol.
S2, the VR HMD 310 establishes a Bluetooth channel with the terminal device 320 to make the Bluetooth connection with the terminal device 320 through the Bluetooth channel.
S3, the VR HMD 310 displays a projection window, and registers a pre-configured window event detector for the projection window, the window event detector is configured to detect an input event acting on the projection window.
S4, the VR HMD 310 displays projection information in the projection window, in which the projection information including information projected to the VR HMD by the terminal device 320.
S5, the VR HMD 310, in response to the input event acting on the projection window, acquires the event type of the input event through the VR HMD 310, and encapsulates the input event as a Bluetooth event matched with the event type.
S6, the VR HMD 310 transmits the Bluetooth event to the terminal device 320 through the Bluetooth channel.
S7, the terminal device 320, in response to the Bluetooth event, projects the projection information corresponding to the Bluetooth event.
S8, the VR HMD 320 displays the projection information corresponding to the Bluetooth event in the projection window.

According to the technical solution of this embodiment of the present disclosure, all steps cooperates with each other, so the user wearing the VR HMD can operate the VR HMD to run the terminal device, thus improving the use experience of the user in watching the projection information with the VR HMD.

### Fourth Embodiment

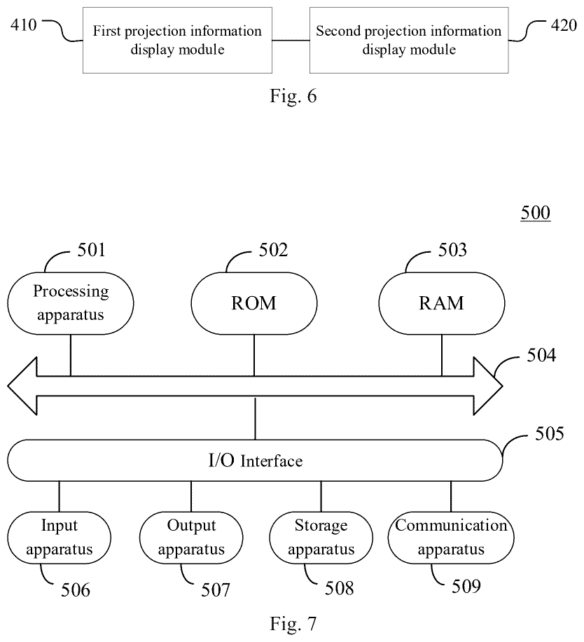

FIG. 6 is a block diagram of an information exchange apparatus according to the Fourth embodiment of the present disclosure, and the apparatus is configured to execute the information exchange method according to any above embodiment. The apparatus and the information exchange method according to each above embodiment belong to the same concept, and the details that are not described in the embodiment of the information exchange apparatus may refer to the above embodiments of the information exchange method. As shown in FIG. 6, the apparatus is configured on a client, the client is deployed on a head-mounted display device (HMD) connected with a terminal device, and the apparatus may include the first projection information display module 410 and the second projection information display module 420.

The first projection information display module 410 is configured to display a projection window, and display projection information in the projection window, the projection information is information projected by the terminal device to the HMD; and
the second projection information display module 420 is configured to, in response to an input event acting on the projection window, display the projection information corresponding to the input event in the projection window.

The information exchange apparatus in the Fourth embodiment of the present disclosure, the VR HMD is connected with the terminal device, and the projection information projected by the terminal device to the VR HMD is displayed in the displayed projection window through the first projection information display module; and the second projection information display module, in response to the input event acting on the projection window, displays the projection information corresponding to the input event in the projection window, and the projection information corresponding to the input event may be projection information generated by the terminal device after responding to the input event. With the above-described apparatus, the user wearing the VR HMD can operate the VR HMD to run the terminal device, thus improving the use experience of the user in watching the projection information with the VR HMD.

The information exchange apparatus according to this embodiment of the present disclosure can execute the information exchange method according to any embodiment of the present disclosure, and is provided with corresponding functional modules for executing the method.

It is to be noted that according to the above embodiment of the information exchange apparatus, all units and modules included are only divided according to functional logic, but are not limited to the above-mentioned division, as long as the corresponding functions can be realized; in addition, the specific names of the functional units are only for the convenience of distinguishing them from each other and are not intended to limit the scope of protection of this present disclosure.

### Fifth Embodiment

Referring to FIG. 7, FIG. 7 illustrates a schematic structural diagram of a head-mounted display device 500 suitable for implementing some embodiments of the present disclosure. The display devices in some embodiments of the present disclosure may include but are not limited to mobile terminals such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal) or the like, and fixed terminals such as a digital TV, a desktop computer, or the like. The display device illustrated in FIG. 7is merely an example, and should not pose any limitation to the functions and the range of use of the embodiments of the present disclosure.

As illustrated in FIG. 7, the display device 500 may include a processing apparatus 501 (e.g., a central processing unit, a graphics processing unit, etc.), which can perform various suitable actions and processing according to a program stored in a read-only memory (ROM) 502 or a program loaded from a storage apparatus 508 into a random-access memory (RAM) 503. The RAM 503 further stores various programs and data required for operations of the display device 500. The processing apparatus 501, the ROM 502, and the RAM 503 are interconnected by means of a bus 504. An input/output (I/O) interface 505 is also connected to the bus 504.

Usually, the following apparatus may be connected to the I/O interface 505: an input apparatus 506 including, for example, a touch screen, a touch pad, a keyboard, a mouse, a camera, a microphone, an accelerometer, a gyroscope, or the like; an output apparatus 507 including, for example, a liquid crystal display (LCD), a loudspeaker, a vibrator, or the like; a storage apparatus 508 including, for example, a magnetic tape, a hard disk, or the like; and a communication apparatus 509. The communication apparatus 509 may allow the display device 500 to be in wireless or wired communication with other devices to exchange data. While FIG. 7 illustrates the display device 500 having various apparatuses, it should be understood that not all of the illustrated apparatuses are necessarily implemented or included. More or fewer apparatuses may be implemented or included alternatively.

### Sixth Embodiment

Particularly, according to some embodiments of the present disclosure, the processes described above with reference to the flowcharts may be implemented as a computer software program. For example, some embodiments of the present disclosure include a computer program product, which includes a computer program carried by a non-transitory computer-readable medium. The computer program includes program codes for performing the methods shown in the flowcharts. In such embodiments, the computer program may be downloaded online through the communication apparatus 509 and installed, or may be installed from the storage apparatus 508, or may be installed from the ROM 502. When the computer program is executed by the processing apparatus 501, the above-mentioned functions defined in the methods of some embodiments of the present disclosure are performed.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

In some implementation modes, the client and the server may communicate with any network protocol currently known or to be researched and developed in the future such as hypertext transfer protocol (HTTP), and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above-mentioned computer-readable medium may be included in the above-mentioned head-mounted display device, or may also exist alone without being assembled into the head-mounted display device.

The above-mentioned computer-readable medium carries one or more programs, and when the one or more programs are executed by the head-mounted device, the head-mounted device is caused to: display a projection window, and display projection information in the projection window, in which the projection information is information projected by the terminal device to the head-mounted display device; and in response to an input event acting on the projection window, display the projection information corresponding to the input event in the projection window.

The computer program codes for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The units involved in the embodiments of the present disclosure may be implemented in software or hardware. Among them, the name of the unit does not constitute a limitation of the unit itself under certain circumstances. For example, the first projection information display module may also be described as “display a projection window, and display projection information in the projection window, in which the projection information is information projected by the terminal device to the head-mounted display device”.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

According to at least one embodiment of the present disclosure, [Example 1] provides an information exchange method, the method is applied to a client, the client is deployed on a head-mounted display device connected to a terminal device, and the method may include:
displaying a projection window, and displaying projection information in the projection window, in which the projection information is information projected by the terminal device to the head-mounted display device; and
in response to an input event acting on the projection window, displaying the projection information corresponding to the input event in the projection window.

According to at least one embodiment of the present disclosure, [Example 2] provides the method of Example 2, in which a virtual keyboard is displayed in the projection window, and when the input event includes a keyboard event acting on the virtual keyboard, the projection information corresponding to the input event includes an input character corresponding to the keyboard event;
and/or, when the input event includes a touch event, the projection information corresponding to the input event includes the projection information in at least one state.

According to at least one embodiment of the present disclosure, [Example 3] provides the method of Example 2, the at least one state includes at least one selected from the group consisting of a sliding state, a page turning state, and a state of converting a partial display state into a complete display state.

According to at least one embodiment of the present disclosure, [Example 4] provides the method of Example 1. after responding to the input event acting on the projection window, the above information exchange method, may further include:
transmitting the input event to the terminal device to cause the terminal device to project the projection information corresponding to the input event in response to the input event.

According to at least one embodiment of the present disclosure, [Example 5] provides the method of Example 4, the transmitting the input event to the terminal device to cause the terminal device to project the projection information corresponding to the input event in response to the input event, may include:
acquiring an event type of the input event, and encapsulating the input event as a Bluetooth event matched with the event type;
transmitting the Bluetooth event through a Bluetooth channel to the terminal device to cause the terminal device to project the projection information corresponding to the Bluetooth event in response to the Bluetooth event.

According to at least one embodiment of the present disclosure, [Example 6] provides the method of Example 5, the above information exchange method, may further include:
registering as a Bluetooth human interface device to serve as an input device of the terminal device for realizing human interface to realize the transmitting operation of the input event;
establishing the Bluetooth channel to the terminal device to realize Bluetooth connection to the terminal device through the Bluetooth channel.

According to at least one embodiment of the present disclosure, [Example 7] provides the method of Example 6, the registering as a Bluetooth human interface device, which may include:
in response to a start instruction of a human interface device service, starting the human interface device service, and registering the started human interface device service, thereby registering as the Bluetooth human interface device, in which the human interface device service is a service used for representing that the Bluetooth is used as the human interface device service for application in a Bluetooth protocol.

According to at least one embodiment of the present disclosure, [Example 8] provides the method of Example 1, after displaying the projection window, the above information exchange method, may further include:
registering a pre-configured window event detector for the projection window, in which the window event detector is configured to detect the input event acting on the projection window.

According to at least one embodiment of the present disclosure, [Example 9] provides an information exchange apparatus, the apparatus is configured in a client, the client is deployed on a head-mounted display device connected to a terminal device, the apparatus may include: the first projection information display module and the second projection information display module;
the first projection information display module is configured to display a projection window, and display projection information in the projection window, in which the projection information is information projected by the terminal device to the head-mounted display device; and
the second projection information display module is configured to, in response to an input event acting on the projection window, display the projection information corresponding to the input event in the projection window.

According to at least one embodiment of the present disclosure, [Example 10] provides the apparatus of Example 9, in which a virtual keyboard is displayed in the projection window, and when the input event includes a keyboard event acting on the virtual keyboard, the projection information corresponding to the input event includes an input character corresponding to the keyboard event;
and/or, when the input event includes a touch event, the projection information corresponding to the input event includes the projection information in at least one state.

According to at least one embodiment of the present disclosure, [Example 11] provides the method of Example 10, the at least one state includes at least one of a sliding state, a page turning state and a state of converting a partial display state into a complete display state.

According to at least one embodiment of the present disclosure, [Example 12] provides the device of Example 9, the above information exchange apparatus, which may further include: a projection information project module;
the projection information project module is configured to, after respond to the input event acting on the projection window, transmit the input event to the terminal device to cause the terminal device to project the projection information corresponding to the input event in response to the input event.

According to at least one embodiment of the present disclosure, [Example 13] provides the apparatus of Example 12, the projection information project module, which may further include: a Bluetooth event encapsulation unit and a projection information project unit;
the Bluetooth event encapsulation unit is configured to acquire an event type of the input event, and encapsulate the input event as a Bluetooth event matched with the event type;
the projection information project unit is configured to transmit the Bluetooth event through a Bluetooth channel to the terminal device to cause the terminal device to project the projection information corresponding to the Bluetooth event in response to the Bluetooth event.

According to at least one embodiment of the present disclosure, [Example 14] provides the device of Example 13, the above information exchange apparatus, which may further include: a Bluetooth human interface device registration module and a Bluetooth channel establishment module;
the Bluetooth human interface device registration module is configured to register as a Bluetooth human interface device to serve as an input device of the terminal device for realizing human interface, realize the transmitting operation of the input event;
the Bluetooth channel establishment module is configured to establish the Bluetooth channel to the terminal device to realize Bluetooth connection to the terminal device through the Bluetooth channel

According to at least one embodiment of the present disclosure, [Example 15] provides the device of Example 14, the Bluetooth human interface device registration module, which may include: a Bluetooth human interface device registration unit;
the Bluetooth human interface device registration unit is configured to, in response to a start instruction of a human interface device service, start the human interface device service, and register the started human interface device service, thereby register as the Bluetooth human interface device, in which the human interface device service is a service used for representing that the Bluetooth is used as the human interface device service for application in a Bluetooth protocol.

According to at least one embodiment of the present disclosure, [Example 16] provides the device of Example 9, the above information exchange apparatus, which may further include: a window event detector registration module;
the window event detector registration module is configured to register a pre-configured window event detector for the projection window, in which the window event detector is configured to detect the input event acting on the projection window.

In addition, while all operations are depicted in a specific order, it is not construed as requiring these operations to be performed in the specific order or in a sequential order. In some context, multitasking and parallel processing may be beneficial. Similarly, although a number of specific implementation details are included in the above discussion, it is not construed as limiting the scope of the present disclosure. Some features described in the context of individual embodiments may also be implemented in combination in a single embodiment. Conversely, the various features described in the context of a single embodiment may also be implemented in multiple embodiments individually or in any suitable combination of sub-embodiments.

1. An information exchange method, applied to a client, wherein the client is deployed on a head-mounted display device connected to a terminal device, and the method comprises:
displaying a projection window and displaying projection information in the projection window, wherein the projection information is information projected by the terminal device to the head-mounted display device; and
in response to an input event acting on the projection window, displaying the projection information corresponding to the input event in the projection window.

2. The method according to claim 1, wherein the input event and the projection information corresponding to the input event comprise at least one of the following:
a virtual keyboard is displayed in the projection window, and when the input event comprises a keyboard event acting on the virtual keyboard, the projection information corresponding to the input event comprises an input character corresponding to the keyboard event; and
when the input event comprises a touch event, the projection information corresponding to the input event comprises the projection information in at least one state.

3. The method according to claim 2, wherein the at least one state comprises at least one selected from the group consisting of a sliding state, a page turning state, and a state of converting a partial display state into a complete display state.

4. The method according to claim 1, wherein after responding to the input event acting on the projection window, the method further comprises:
transmitting the input event to the terminal device to cause the terminal device to project the projection information corresponding to the input event in response to the input event.

5. The method according to claim 4, wherein the transmitting the input event to the terminal device to cause the terminal device to project the projection information corresponding to the input event in response to the input event, comprises:
acquiring an event type of the input event, and encapsulating the input event as a Bluetooth event matched with the event type; and
transmitting the Bluetooth event through a Bluetooth channel to the terminal device to cause the terminal device to project the projection information corresponding to the Bluetooth event in response to the Bluetooth event.

6. The method according to claim 5, further comprising:
registering as a Bluetooth human interface device to serve as an input device of the terminal device for realizing human interface to realize the transmitting operation of the input event; and
establishing the Bluetooth channel to the terminal device to realize Bluetooth connection to the terminal device through the Bluetooth channel.

7. The method according to claim 6, wherein the registering as a Bluetooth human interface device comprises:
in response to a start instruction of a human interface device service, starting the human interface device service, and registering the started human interface device service, thereby registering as the Bluetooth human interface device, wherein the human interface device service is a service used for representing that the Bluetooth is used as the human interface device service for application in a Bluetooth protocol.

8. The method according to claim 1, wherein after displaying the projection window, the method further comprising:
registering a pre-configured window event detector for the projection window, wherein the window event detector is configured to detect the input event acting on the projection window.

9. (canceled)

10. A head-mounted display device, comprising:
at least one processor; and
a storage, configured to store at least one program,
wherein when the at least one program is executed by the at least one processor, the at least one processor implements an information exchange method, applied to a client, wherein the client is deployed on a head-mounted display device connected to a terminal device, and the method comprises:
displaying a projection window and displaying projection information in the projection window, wherein the projection information is information projected by the terminal device to the head-mounted display device; and
in response to an input event acting on the projection window, displaying the projection information corresponding to the input event in the projection window.

11. A computer-readable storage medium, the computer-readable storage medium storing a computer program, wherein the computer program when executed by a processor, realizes an information exchange method, applied to a client, wherein the client is deployed on a head-mounted display device connected to a terminal device, and the method comprises:
displaying a projection window and displaying projection information in the projection window, wherein the projection information is information projected by the terminal device to the head-mounted display device; and
in response to an input event acting on the projection window, displaying the projection information corresponding to the input event in the projection window.

12. The head-mounted display device according to claim 10, wherein the input event and the projection information corresponding to the input event comprise at least one of the following:
a virtual keyboard is displayed in the projection window, and when the input event comprises a keyboard event acting on the virtual keyboard, the projection information corresponding to the input event comprises an input character corresponding to the keyboard event; and
when the input event comprises a touch event, the projection information corresponding to the input event comprises the projection information in at least one state.

13. The head-mounted display device according to claim 12, wherein the at least one state comprises at least one selected from the group consisting of a sliding state, a page turning state, and a state of converting a partial display state into a complete display state.

14. The head-mounted display device according to claim 10, wherein after responding to the input event acting on the projection window, the device further comprises:
transmitting the input event to the terminal device to cause the terminal device to project the projection information corresponding to the input event in response to the input event.

15. The head-mounted display device according to claim 14, wherein the transmitting the input event to the terminal device to cause the terminal device to project the projection information corresponding to the input event in response to the input event, comprises:
acquiring an event type of the input event, and encapsulating the input event as a Bluetooth event matched with the event type; and
transmitting the Bluetooth event through a Bluetooth channel to the terminal device to cause the terminal device to project the projection information corresponding to the Bluetooth event in response to the Bluetooth event.

16. The head-mounted display device according to claim 15, further comprising:
registering as a Bluetooth human interface device to serve as an input device of the terminal device for realizing human interface to realize the transmitting operation of the input event; and
establishing the Bluetooth channel to the terminal device to realize Bluetooth connection to the terminal device through the Bluetooth channel.

17. The head-mounted display device according to claim 16, wherein the registering as a Bluetooth human interface device comprises:
in response to a start instruction of a human interface device service, starting the human interface device service, and registering the started human interface device service, thereby registering as the Bluetooth human interface device, wherein the human interface device service is a service used for representing that the Bluetooth is used as the human interface device service for application in a Bluetooth protocol.

18. The head-mounted display device according to claim 10, wherein after displaying the projection window, the device further comprising:
registering a pre-configured window event detector for the projection window, wherein the window event detector is configured to detect the input event acting on the projection window.

19. The computer-readable storage medium according to claim 11, wherein after responding to the input event acting on the projection window, the storage medium further comprises:
transmitting the input event to the terminal device to cause the terminal device to project the projection information corresponding to the input event in response to the input event.

20. The computer-readable storage medium according to claim 19, wherein the transmitting the input event to the terminal device to cause the terminal device to project the projection information corresponding to the input event in response to the input event, comprises:
acquiring an event type of the input event, and encapsulating the input event as a Bluetooth event matched with the event type; and
transmitting the Bluetooth event through a Bluetooth channel to the terminal device to cause the terminal device to project the projection information corresponding to the Bluetooth event in response to the Bluetooth event.

21. The computer-readable storage medium according to claim 20, further comprising:
registering as a Bluetooth human interface device to serve as an input device of the terminal device for realizing human interface to realize the transmitting operation of the input event; and
establishing the Bluetooth channel to the terminal device to realize Bluetooth connection to the terminal device through the Bluetooth channel.
